(19) United States
(12) Patent Application Publication
(10) Pub. No.: US 2009/0235177 A1
(43) Pub. Date: Sep. 17, 2009

(54) MULTI-MONITOR REMOTE DESKTOP ENVIRONMENT USER INTERFACE

(75) Inventors: Elton Saul, Kirkland, WA (US); Casey J. Dvorak, Redmond, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 12/049,180

(22) Filed: Mar. 14, 2008

(51) Int. Cl. G06F 3/00

(52) U.S. Cl. 715/740

(57) ABSTRACT

Representation of multiple displays of a remote computing system within a local display of a local computing system. This permits a user at the local computing system to interface with the remote computing system through the representation of the remote displays that are represented at the local display. The local computer receives representation of the display state or content for multiple remote displays associated with the remote computing system. The local computer then causes representations of those remote displays to be rendered on the local display. The content of the active display of the remote computing system is caused to be emphasized in some manner at the local display, while the content of the inactive display(s) of the remote computing system is rendered in a deemphasized manner.

### BACKGROUND

Remote desktop applications permit an individual to use a local computer to access a remote computer to thereby at least partially simulate that user's presence in front of the remote computer. The user can then use the local input devices (e.g., a keyboard and a mouse) to interface with the remote computer, and view a representation of the remote monitor using a local monitor. In some cases, audio output from the remote computer may also be rendered at the local computer.

In order to facilitate this interaction, virtual output drivers (e.g., display and sound drivers) at the remote computer provide output information over the intervening network to the local computer, which renders the output information using the local display and speakers. The user may use local input devices (e.g., a mouse or a keyboard) to enter input information, which is then transmitted to the remote computer, where virtual input drivers cause the input information to change state at the remote computer. Remote desktop protocols permit the marshalling of this input and output information over the network to thereby simulate the remote desktop experience.

### BRIEF SUMMARY

At least some embodiments described herein relate to the representation of multiple displays of a remote computing system within a local display of a local computing system. This permits a user at the local computing system to interface with the remote computing system by representing the content of the remote displays within the local display.

The local computer receives representations of the display state or content of the multiple remote displays associated with the remote computing system. The local computer then causes representations of those remote displays to be rendered on the local display. The content of the active display of the remote computing system is caused to be emphasized in some manner at the local display. For example, perhaps the content of the “active” display is rendered in full scale, the “active” display being the display that is ready to be operated upon. On the other hand, the content of the inactive display(s) of the remote computing system is rendered in a deemphasized manner. For example, perhaps only smaller scale, perhaps even thumbnail representations of the content of the inactive display may be rendered at the local computing system. In one embodiment, the relative position of the representations of the remote displays as displayed at the local display conveys information regarding the layout of the virtual desktop at the remote computing system.

Accordingly, remote desktop applications are enabled that permit multiple remote monitors to be represented using a lesser number of local displays. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates an example computing system that may be used to employ embodiments described herein;

FIG. 2 illustrates a network environment in which a user at a local computing system may connect to a multi-display remote computing system;

FIG. 3 illustrates a flowchart of a method for connecting to a multi-display remote computing system in accordance with embodiments described herein;

FIG. 4 illustrates an example user interface in which content from multiple remote displays are rendered on a single local user interface;

FIG. 5 illustrates a flowchart of a method for the local computing system to respond to user input to thereby alter the rendering of the display states on the local display; and

FIG. 6 illustrates a flowchart of a method for changing the display state of the remote displays in response to user input.

### DETAILED DESCRIPTION

In accordance with embodiments described herein, a representation of multiple displays of a remote computing system may be rendered within a local display of a local computing system. The user at the local computing system may then interface with the representations of the multiple remote displays as represented at the local display.

The local computer receives representation of the display state or content for multiple remote displays associated with the remote computing system. The local computer then causes representations of those remote displays to be rendered on the local display. The content of the active display of the remote computing system is caused to be emphasized in some manner at the local display. On the other hand, the content of the inactive display(s) of the remote computing system is rendered in a deemphasized manner. In one embodiment, the relative position of the representations of the display content of the various remote displays as displayed at the local display conveys information regarding the layout of the virtual desktop at the remote computing system. Accordingly, remote desktop applications are enabled that permit multiple remote displays to be represented at a lesser number of local displays, or even a single local display.

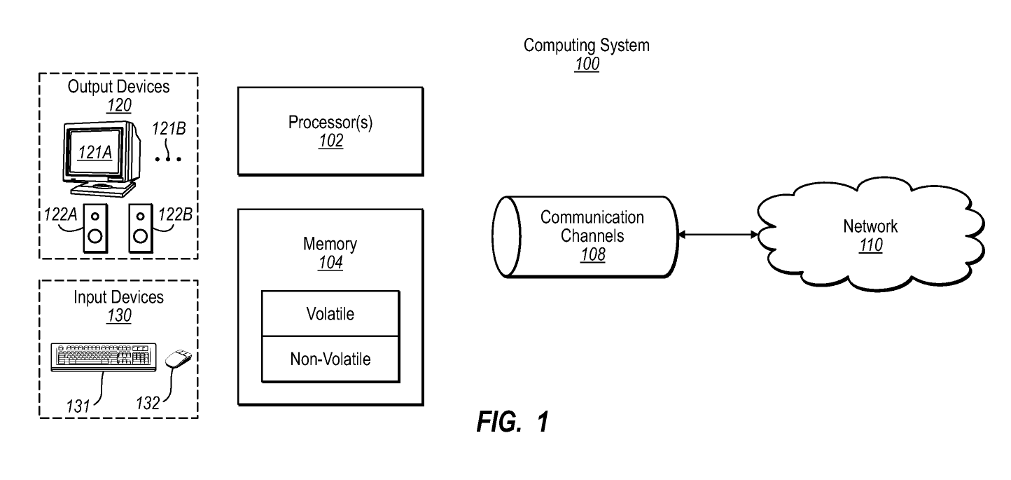

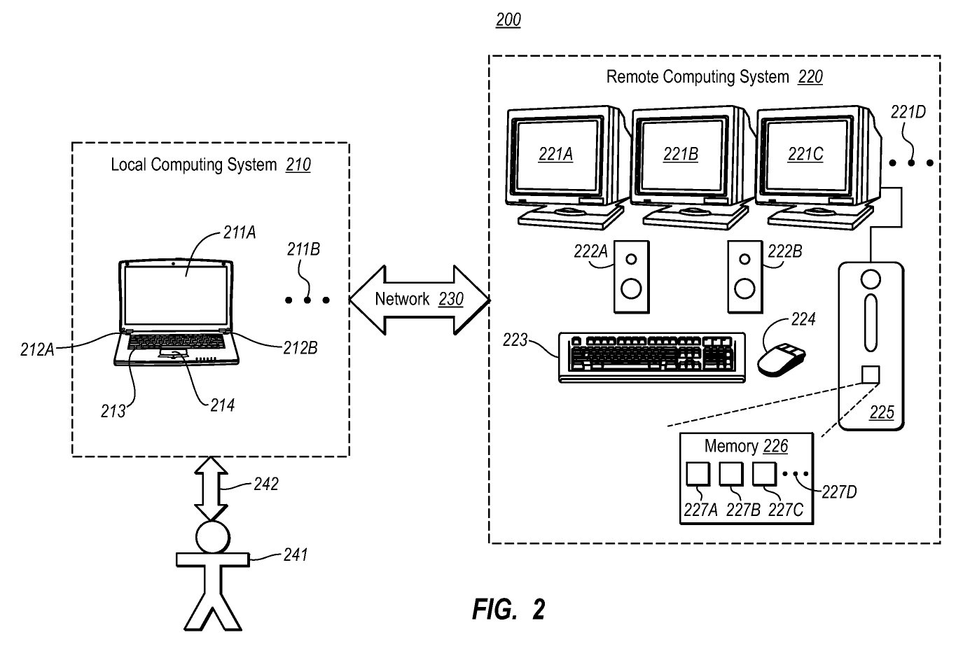

First, some introductory discussion regarding a computing system will be described with respect to FIG. 1. Then, various embodiments of the multi-display remote desktop mechanism will be described with respect to FIGS. 2 through 6.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one processor, and a memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

The computing system 100 also includes output devices 120 and input devices 130 that permit a user to interact with the computing system 100. The nature and form of such input and output devices will differ depending on the nature and form of the computing system. As previously mentioned, computing systems are now taking a wide variety of forms. However, as an example only, the output devices 120 are illustrated as including a display 121A amongst potentially other displays as represented by the horizontal ellipses 121B. In addition, the output devices 120 are illustrated as including speakers 122A and 122B. The input devices 130 would also differ depending on the form of the computing system 100. As one example, the input devices 130 might include a keyboard 131 and a mouse 132.

In the description that follows, embodiments are described with reference to acts that are performed by one or more computing systems. If such acts are implemented in software, one or more processors of the associated computing system that performs the act directs the operation of the computing system in response to having executed computer-executable instructions. An example of such an operation involves the manipulation of data. The computer-executable instructions (and the manipulated data) may be stored in the memory 104 of the computing system TOO.

Computing system 100 may also contain communication channels 108 that allow the computing system 100 to communicate with other message processors over, for example, network 110. Communication channels 108 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

FIG. 2 illustrates a network environment 200 that includes a local computing system 210 and a remote computing system 220 communicating over network 230. The local and remote computing systems 210 and 220 may each be structured as described above for the computing system 100. The local computing system 210 is illustrated as being a laptop, and the remote computing system is illustrated as being a multi-monitor computing system 220. However, the exact physical form of the computing systems may vary widely.

The remote computing system 220 includes various output devices including displays and speakers. The remote computing system 220 is illustrated as including three displays 221A, 221B and 221C (referred to collectively as “displays 221”). The horizontal ellipses 221D represents, however, that the remote computing system 220 may have any multiple number of displays, whether two, three, or more. The use of multiple displays aids greatly in the ability of the user to view information. In some cases, for example, a user might put information of one type on one display, another type on another display, and other information on yet another display. As the user works with such a multiple display system, the user may become accustomed to the presentation of certain content type in certain displays. For example, a stock trader may have one display presenting real-time stock quotes, another display may be used for e-mail, another display may be used to perform research on various stocks, and so forth.

The various remote displays 221A, 221B and 221C are illustrated as being physical displays at the remote computing system 220. In that case, the principles herein simulate physical presence in front of the remote displays 221A, 221B and 221C. However, the remote displays 221A, 221B and 221C may also simply be virtual displays, each represented by a virtual display adaptor. Thus, the virtual remote displays 221A, 221B and 221C may be completely unrelated to the actual number of physical displays at the remote computing system 220. Perhaps the remote computing system 220 only has a single display, or even no displays at all, but the use of virtual displays 221A, 221B and 221C allows the remote desktop application to simulate presence in front of the remote computing system 220, only with much more display capability (three virtual displays versus one physical display) than is actually available to the user at the remote computing system 220. Therefore, when the terms “remote display” are used in this description and in the claims, the term should be interpreted broadly to include a physical remote display or a virtual remote display.

The remote computing system 220 also may include output devices in the form of speakers, such as speakers 222A and 222B (referred to collectively as “speakers 222”). The displays 221 and speakers 222 receive their content from the processing unit 225. In this embodiment, the remote computing system 220 is shown as including input devices in the form of a keyboard 223 and mouse 224. However, the particular type of input and output devices will change depending on the computing system. In some cases, some or even all of the input and output devices may be physically integrated within the computing system.

The local computing system 210 also includes a display 211A, amongst potentially one or more auxiliary displays as represented by the horizontal ellipses 211B. The local computing system 210 may also include speakers 212A and 212B, which in this case are built in. The local computing system 210 also includes input devices in the form of a built-in keyboard 213 and touchpad 214. As will become apparent to those of ordinary skill in the art after having read this description, there is no restriction on the physical form of the local and remote computing systems, except that the principles as described herein operate in an environment in which the remote computing system 220 is presented on the local computing system as including displays (whether those remote displays have a correlation to actual physical remote displays, or whether they are purely virtual displays) and in which the local computing system 210 presents the content of those multiple remote displays in a fewer number of local displays. In one embodiment, the local computing system 210 has a single display.

When performing a remote desktop connection in the environment 200, the user 241 of the local computing system 210 may interface (as represented by bi-directional arrow 242) with the local computing system 210. The various user inputs into the local computing system 210 are transmitted to the remote computing system 220 over the network 230. The user inputs are then entered into the remote computing system 220 to allow the user to change the state of the remote computing system 220 much like the user 241 could do if present before the remote computing system 220. Some of the user input may actually cause a change in the display state of one or more of the displays 221.

Upon initialization of the remote desktop application, the display state of the various displays 221 at the remote computing system 220 (whether physical or virtual displays) may be transmitted (albeit perhaps in compressed form) over the network 230 to the local computing system 220. Even though the local computing system 210 has a fewer number of displays, and perhaps even just one display, the representations of the display content that was to be displayed on the remote displays 221 may be rendered instead on the local display 211 A.

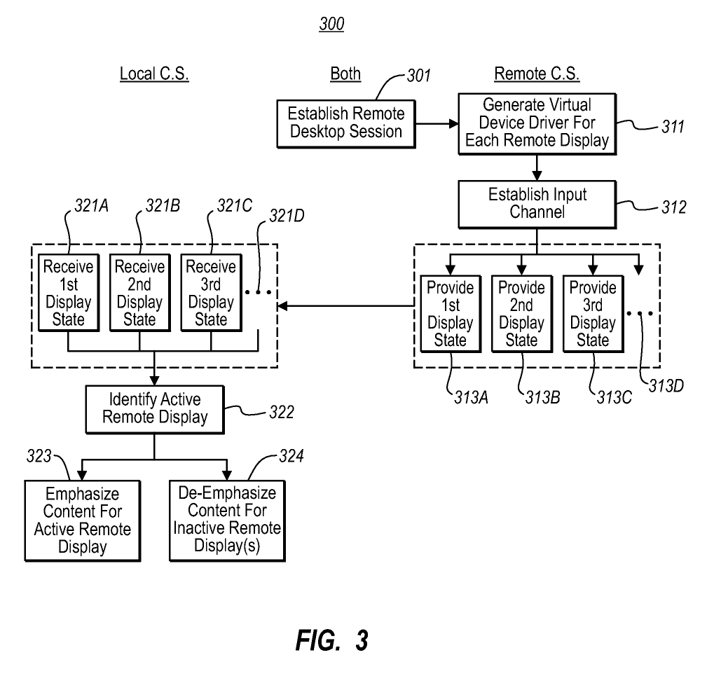

FIG. 3 illustrates a flowchart of a method 300 for initiating the representation of multiple remote displays associated with a remote computing system (whether physical or virtual remote displays) on a local computing system with a lesser number (or even a single) of displays. To keep the example clearer, it will be assumed throughout the remainder of this description that the local computing system 210 has only one display to render information. However, given the information provided herein regarding how multiple displays could be represented in a single display, it would be apparent how this principle could be extended to, for example, presenting content for four remote displays states onto two local displays. For instance, one could simply have two remote display states rendered on one local display, and two on another. Alternatively, one could represent three remote display states on one local display, and another local display might present the display state for just a single remote display.

Referring to FIG. 3, some of the acts in initiating the multi-display remote desktop session are performed by the local computing system. Such acts are illustrated in the left column of FIG. 3 under the heading “Local C.S.” Other acts may be performed by the remote computing system, and are illustrated in the right column of FIG. 3 under the heading “Remote C.S.”. Yet other acts results from the mutual collaboration of both local and remote computing systems, and are illustrated in the center column of FIG. 3 under the heading “Both”.

The illustrated method 300 of FIG. 3 may be initiated when a remote desktop session is established (act 301). For instance, there may be remote desktop components on both the local computing system 210 and the remote computing system 220. The user might use a logon feature to authenticate.

The remote computing system then generates a virtual device driver for each remote display to be represented at the local computing system (act 311). Once again, the remote display may be an actual physical remote display, or it may be a virtual display. Referring to FIG. 2, the remote computing system 220 is illustrated as including a memory 226 illustrated in expanded form. The memory 226 includes three virtual device drivers 227A, 227B, and 227C, one for each of the remote displays 221A, 221B, 221C. If there were more remote displays as represented by the o m ellipses 221D, there may be more virtual device drivers as represented by the horizontal ellipses 227D.

In the case where the remote displays being represented to the local computing system are actual physical remote displays, instead of providing display content to the remote displays 221A, 221B, and 221C, the virtual display drivers provide the corresponding display content over the network 230 to the local computing system as will be described. Accordingly, when referring to content of a remote display, it is the content generated by the virtual device driver that is being referenced, where that virtual device driver presents that content to the local computing system, rather than actually providing that content necessarily to the corresponding remote display. Nevertheless, the virtual device drivers are set up to present the content using the dimensions of the corresponding remote display. Accordingly, even though the display state corresponding to the remote displays 221 is being altered, there need not be anything necessarily being displayed on the remote displays 221. Instead, the display content is being diverted to the local computing system 210. This concept allows the emulation of virtual remote displays as well as described above, in which there might not be any physical remote display corresponding to the particular virtual remote display being represented at the local computing system.

In addition, the remote computing system establishes an input channel whereby user input from the local computing system 210 may affect the remote computing system state (act 312). For instance, such user input on the local computing system 210 may even affect the display state of the virtual device drivers 227A through 227C. Although act 311 is shown before act 312 in FIG. 3, there is no special timing relationship required for these two acts.

Then, the display state (e.g., the display content) for each of the remote displays is provided over the network 230 to the local computing system 210. For example, in FIG. 3, the act of providing a representation of a display state of the first remote display is illustrated as act 313A. The virtual device driver 227A of FIG. 2 may be configured to cause that display state to be provided. A similar act for the representation of the display state of the second remote display is illustrated as act 313B at the direction of the second virtual device driver 227B. Likewise, the representation of the display state of the third remote display is illustrated as act 313C and may be provided at the direction of the third virtual device driver 227C. This may continue for other remote displays as represented by the horizontal ellipses. The display state for a given remote display may include, for example, the display content that would fit into the corresponding display, but has been diverted using the corresponding virtual display driver. Such display state might be compressed to preserve network bandwidth.

These various display states are received by the local computing system 210. Referring to FIG. 3, the acts of receiving the representations of the display state are represented by acts 321A through 321D, which correspond to the respective display states provided in acts 313A through 313D.

The local computing system may also identify the active display (act 322). An active display is the display that is ready to be operated upon, and may change from one display to another through the course of interaction with the user. For instance, the local computing system 210 may select the first remote display 221A to be active. The local computing system then emphasizes the representation of the display state of the active display in the local display (act 323). For instance, the display content of the first remote display 221A as provided by the virtual display driver 227A, if that is the active display, is emphasized in the local display 211A. The display states of the other remote displays are presented in a deemphasized manner in the local display 211 A (act 324).

There are a variety of ways to emphasize and deemphasize the display states of different displays. One mechanism to emphasize display content is to cause a full sized representation of that display content to appear in the local display. One mechanism to deemphasize display content is to reduce the size of the displayed content to at least less than the size of the emphasized display content. In one embodiment, perhaps a mere thumbnail representation of the display content is presented.

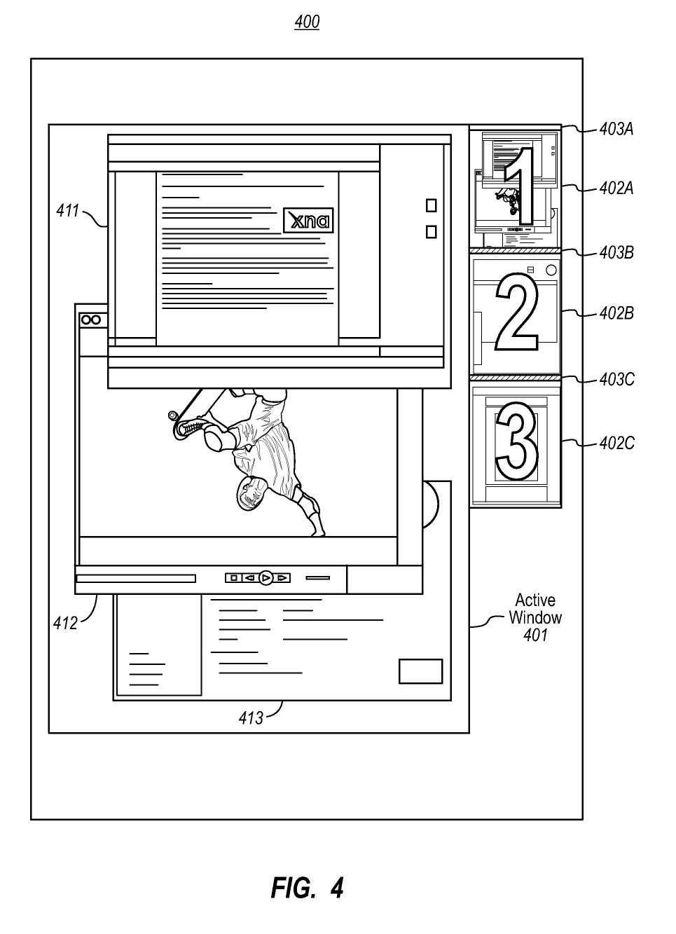

FIG. 4 illustrates the user interface 400 that may be presented using the local display 211A of the local computing system 400. The user interface 400 includes an active window 401, which displays full-sized content of the display state of the active remote display. In this case, the active window 401 is illustrated as including three component windows 411, 412 and 413 overlaid on top of each other. For instance, if the remote display 221A is active, the active window 400 at the local computing system would display the content that was generated by the local virtual device driver 227A. The user interface also includes a thumbnail view of each of the remote displays. Thumbnail views 402A, 402B, and 402C are reduced-size representations of all of the displays, and include corresponding status bars 403A, 403B, and 403C. The corresponding status bars represent whether or not the display content for that view is within the active window.

For instance, thumbnail view 402A shows a reduced-size form of the display content corresponding to the first remote display content generated by the virtual device driver 227A. Since the first remote display content is presently the active display, the full-sized form of that display content is presently shown in the active window 401 The corresponding status bar 403A does not include cross-hatching, which represents that this is the currently active display. Thumbnail view 402B shows a reduced-size form of the display content corresponding to the second remote display content generated by the virtual device driver 227B. This is not an active display as represented by the corresponding status bar 403B being cross-hatched. Likewise, thumbnail view 402C shows a reduced-size form of the display content corresponding to the third remote display content generated by the virtual device driver 227C, which is also not an active display as represented by the corresponding status bar 403C being cross-hatched. Of course, other indicators of active versus inactive displays may be used.

In one embodiment, the position of the thumbnail views conveys a relative position of each of the displays with respect to each other in the virtual desktop of the remote computing system. For instance, thumbnail view 402A appears above thumbnail view 402B, which appears above thumbnail view 402C. This would be consistent with a virtual desktop in which the remote displays 221, even if placed horizontally on a desk, actually show a vertically stacked desktop, with remote display 221A showing the upper portion, remote display 221B showing the middle portion, and remote display 221 C showing the lower portion.

If, on the other hand, the virtual desktop was horizontal, a horizontal representation of the thumbnail views may be represented next to the active window 401. Since the active window 401 shows a full-sized representation of the active display, it is possible that the active window 401 might be larger than the display 211A. In that case, scroll bars may appear to allow the user to navigate through the active window 401. In that case, the thumbnail views might be more conveniently situated above the active window 401, perhaps in partially transparent form.

In one embodiment, the relative position of the thumbnail views 402A, 402B and 402C may be altered to thereby affect the layout of the virtual desktop of the remote computing system. To move from one display to another, the user might click on the corresponding thumbnail view, perhaps causing the prior active display content to disappear from the active window 401, and causing the display content of the new active display to appear in the active window 401. In another embodiment, as a pointer is moved over a thumbnail view of a particular inactive display, a portion of that inactive display may be magnified.

To facilitate convenient interaction between the multiple views 402A through 402C, items may be dragged from the active window into a thumbnail view. For instance, an item might be selected from the active window, then dragged towards the thumbnail view corresponding to the display into which the item is to be dropped. As the pointer enters the thumbnail view boundaries, the item may be dropped. Optionally, a virtual magnifying glass control might appear around the pointer over the thumbnail view to permit precision placement of the item during the drop operation. Alternatively, as the item is dragged over the thumbnail view, the display content for that thumbnail view might at least temporarily appear in the active window, regardless of whether than target display becomes the active display.

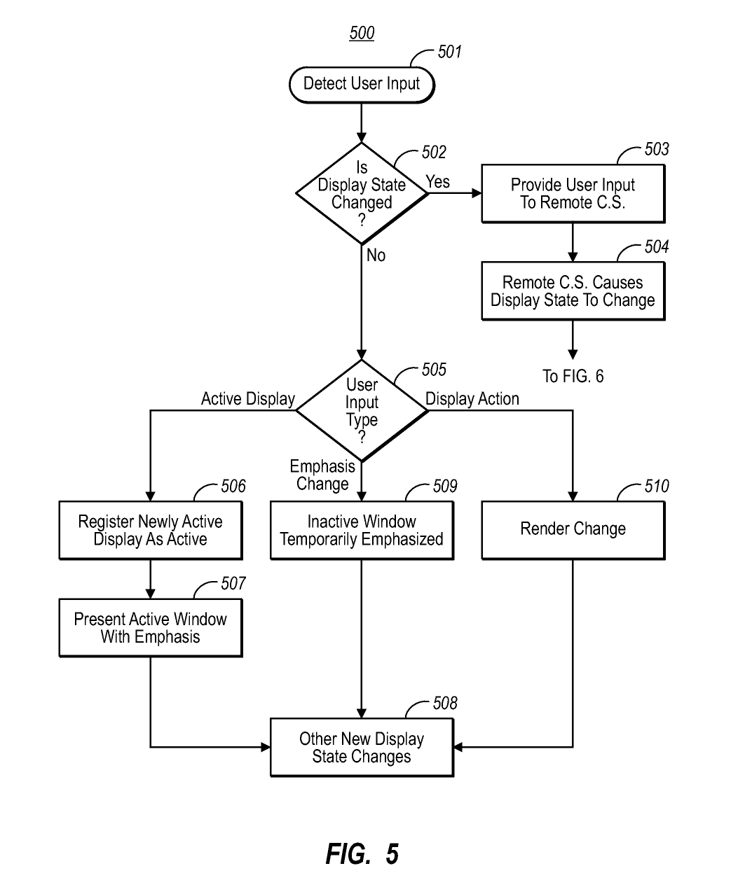

FIG. 5 illustrates a flowchart of a method 500 for the local computing system to respond to user input to thereby alter the rendering of the display states on the local display. The method 500 is initiated upon detection of user input at the local computing system (act 501). When user input is detected, if the user input changes the display state itself (Yes in decision block 502), the user input information is provided by the local computing system over the network to the remote computing system (act 503). The input channel of the remote computing system then causes the display state of the appropriate remote monitor to be altered (act 504). The altered display state for that remote display is then generated by the corresponding virtual device driver, and provided over the network to the location computing system, where the altered display state is rendered. An example of user input that might change the display state of a display is, for example, when a user types text into a displayed word processing document. If user input should cause a change in the state of the remote computing system but not the display state, that user input may also be provided to the remote computing system, so that the state of the remote computing system may change, even though the display state at the remote computing system does not change.

If the user input is not the type that causes a change in display state (No in decision block 502), the various actions caused may further depend on the type of user input. If the user input is of the type that causes the active display to change (“Active Display” in decision block 505), then the newly active display is registered as active (act 506), and the active window is represented with emphasis (act 507). For instance, in the example user interface 400 of FIG. 4, the user input might be the movement of the pointer over a thumbnail view of an inactive display, then selecting that display for activation. The corresponding display content may then be presented in full size within the active window. In addition to changing the active view, other non-display state changes may occur at the local computing system as warranted by the user input (act 508).

If the user input is of the type that causes the emphasis change (“Emphasis Change” in decision block 505), the active display is not changed, but an inactive window is temporarily emphasized (act 509). For instance, in a drag and drop operation in the user interface 400 of FIG. 4, perhaps when the user drops an item into an inactive display, the inactive display is temporarily emphasized in full view within the active window to allow the user to more precisely select the portion of the display content into which to drop the item. Also, any further non-display state changes may occur (act 508).

If the user input is merely a rendering change (“Display Action” in decision block 505), but does not cause an actual change in display state, a change in active window, or an emphasis change, the rendering change is merely performed (act 510). For instance, if the pointer is moved, that the icon representing that pointer may be moved on the display.

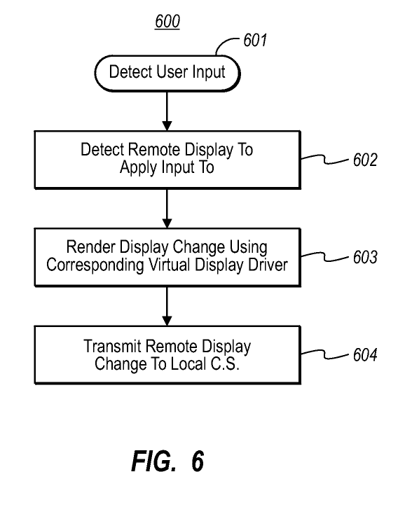

FIG. 6 illustrates a flowchart of a method 600 for changing the display state of the remote displays in response to user input. As mentioned above, the user input at the local computing system might cause the display state to actually change at the remote computing system (Yes in decision block 502 of FIG. 5). The user input information is transmitted to the remote computing system (act 503 in FIG. 5). The method 600 of FIG. 6 picks up from there.

In particular, the remote computing system receives the user input (act 601), detects a remote display that the change would be applied to (act 602), and then uses the appropriate virtual display driver to render the appropriate change in the display content corresponding to that remote display (act 603). The display state change is then transmitted to the local computing system (act 604).

Accordingly, the principles described herein permit content from multiple remote displays to be intuitively represented in the lesser number, or perhaps even a single display. In some embodiments, the relative positions of the remote displays remains intuitively represented.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising one or more computer-readable media having thereon computer-executable instructions that, when executed by one or more processors of a local computing system, causes the computing system local computing system to perform a method for representing a plurality of remote displays associated with a remote computing systems a lesser number of displays at the local computing system, the method comprising:
an act of accessing a representation of a display state of a first remote display of the remote computing system;
an act of accessing a representation of a display state of a second remote display of the remote computing system;
an act of causing an emphasized representation of the display state of the first remote display to be rendered at a local display of the local computing system;
an act of causing a deemphasized representation of the display state of the second remote display to be rendered at the local display of the local computing system; and
in response to user input at the local computer, an act of emphasizing at the local display the display state of the second remote display, and deemphasizing at the local display the display state of the first remote display.

2. The computer program product in accordance with claim 1, wherein the method further comprising:
an act of identifying that the representation of the display state of the first remote display is active;
an act of detecting user input at the local computer while the representation of the display state of the first remote display is identified as active; and
in response to the detection of the user input, an act of providing input information to the remote computing system sufficient to cause the display state of the first remote display at the remote computing system to change.

3. The computer program product in accordance with claim 1, wherein the act of causing an emphasized representation of the display state of the first remote display to be rendered at a local display of the local computing system comprises:
an act of causing a full sized version of the display state of the first remote display to be rendered at the local display.

4. The computer program product in accordance with claim 3, wherein the full sized version of the display state of the first remote display may be resized on the local display in response to user input.

5. The computer program product in accordance with claim 3, wherein the act of causing a deemphasized representation of the display state of the second remote display to be rendered at the local display of the local computing system comprises:
an act of causing a smaller representation of the display state of the second remote display to be rendered at the local display.

6. The computer program product in accordance with claim 1, wherein the act of causing a deemphasized representation of the display state of the second remote display to be rendered at the local display of the local computing system comprises:
an act of causing a smaller representation of the display state of the second remote display to be rendered at the local display, the smaller representation being smaller than the representation of the display state of the first remote display.

7. The computer program product in accordance with claim 6, wherein the smaller representation of the display state of the second remote display is at a relative position with respect to the larger representation of the display state of the first remote display so as to represent a relative position of the second remote display with respect to a first remote display within a virtual desktop of the remote computing system.

8. The computer program product in accordance with claim 1, wherein the representation of the display state of the second remote display is at a relative position with respect to the representation of the display state of the first remote display so as to represent a relative position of the second remote display with respect to a first remote display within a virtual desktop of the remote computing system.

9. The computer program product in accordance with claim 8, wherein the method further permits the relative position at the local display of the representation of the display state of the first remote display to be changed with respect to the representation of the display state of the second remote display, to thereby effect a corresponding change in the virtual desktop layout.

10. A computer program product in accordance with claim 8, wherein when a user-manipulatable pointer is positioned above a deemphasized representation of a display state of a remote display, at least a portion of the display state of that remote display is magnified.

11. A computer program product in accordance with claim 8, wherein an item in the display state of the first remote display may be dragged and dropped using an input device associated with the local display into the representation of the display state of the second remote display.

12. The computer program product in accordance with claim 1, wherein the method further comprises:
an act of accessing a representation of a display state of a third remote display of the remote computing system;
an act of causing a deemphasized representation of the display state of the third remote display to be rendered at the local display of the local computing system; and
in response to user input at the local computer, an act of emphasizing at the local display the display state of the third remote display, and deemphasizing at the local display the display state of the first remote display.

13. The computer program product in accordance with claim 12,
wherein the representation of the display state of the second remote display is at a relative position with respect to the representation of the display state of the first remote display so as to represent a relative position of the second remote display with respect to the first remote display within a virtual desktop of the remote computing system, and
wherein the representation of the display state of the third remote display is at a relative position with respect to the representation of the display states of the first and second remote displays so as to represent a relative position of the third remote display with respect to the first and second remote displays within the virtual desktop of the remote computing system.

14. The computer program product in accordance with claim 1, wherein the lesser number of displays at the local computing system is just a single local display.

15. The computer program product in accordance with claim 1, wherein the one or more computer-readable media are physical storage and/or memory media.

16. A method for representing a plurality of remote displays associated with a remote computing systems in a single local display at the local computing system, the method comprising:
an act of receiving a representation of a display content of a first remote display of the remote computing system from the remote computing system;
an act of receiving a representation of a display content of a second remote display of the remote computing system from the remote computing system;
an act of identifying an active display of the remote computing system;
an act of initially causing a full scale representation of the display content of the active display to be rendered at the local display of the local computing system;
an act of initially causing a smaller scale representation of the display content of whichever display is not active to be rendered at the local display of the local computing system; and
an act of providing a user input mechanism at the local computer that permits the representations of the display content of the first and second remote displays to be manipulated at the local computer, wherein in response to some user input at the user input mechanism, the active display of the first and second remote displays is altered, causing a relative resizing at the local display of the representation of the display content of the first and second remote displays.

17. The method in accordance with claim 16, wherein the representation of the display content of the second remote display is at a relative position at the local display with respect to the representation of the display content of the first remote display so as to represent a relative position of the second remote display with respect to a first remote display within a virtual desktop of the remote computing system.

18. A method for representing a plurality of remote displays associated with a remote computing systems a lesser number of displays at the local computing system, the method comprising:
an act of accessing a representation of display content for each of a plurality of remote displays of the remote computing system;
an act of identifying which of the plurality of remote displays is to be made active when rendered at the local display of the local computing system, wherein the identity of the active display may change at the local display in response to user input at the local display;
an act of causing an emphasized representation of the display content of whichever of the plurality of remote displays is identified as active; and
an act of causing a deemphasized representation of the display content of the one or more remote displays that are not identified as active.

19. The method in accordance with claim 18, wherein the representations of the display content of the plurality of remote displays are relatively positioned at the local display so as to represent a relative position of the plurality of remote displays within a virtual desktop of the remote computing system.

20. The method in accordance with claim 18, further comprising:
in response to user input, an act of dragging and dropping an item from one representation of the display content of one remote display into a representation of the display content of another remote display.
